(19) United States
(12) Patent Application Publication
(10) Pub. No.: US 2012/0187843 A1
(43) Pub. Date: Jul. 26, 2012

(54) CLOSED DRIFT ION SOURCE WITH SYMMETRIC MAGNETIC FIELD

(76) Inventor: John E. Madocks, Tucson, AZ (US)

(21) Appl. No.: 13/388,531

(22) PCT Filed: Aug. 3, 2010
(86) PCT No.: PCT/US10/44235

§ 371 Date: Apr. 13, 2012

Related U.S. Application Data
(60) Provisional application No. 61/273,309, filed on Aug. 3, 2009.

(51) Int. Cl. H05H 1/46; H01J 27/02

(52) U.S. Cl. 315/111.41; 313/361.1

(57) ABSTRACT

A closed drift ion source is provided comprising a single magnetic source, a first pole and a second pole. The ends of the first and second poles are separated by a gap. The magnetic source is disposed proximate to one of the first pole and second pole. A first magnetic path is provided between one magnetic pole of the single magnetic source and the end of the first pole. A second magnetic path is provided between the other magnetic pole of the single magnetic source and the end of the second pole. The first and second magnetic paths are selectively constructed to produce a symmetrical magnetic field in the gap.

### CROSS-REFERENCE TO RELATED APPLICATIONS

This application claims priority of United States Provisional Patent Application Ser. No. 61/273,309 filed Aug. 3, 2009, which is incorporated herein by reference.

### FIELD OF THE INVENTION

This invention pertains to in general an ion beam source, and in particular to a closed drift ion source.

### BACKGROUND

Closed drift type ion sources are used today for a variety of industrial deposition, etching and surface modification applications. Closed drift type ion sources include both extended acceleration channel closed drift ion sources and anode layer type ion sources. Prior U.S. Pat. No. 6,919,672, by the same inventor as the present invention, provides a significant improvement over prior art ion sources by creating a balanced, symmetric magnetic field in the closed drift confinement region. In '672 the magnetic field is also shaped to confine electrons in the center of the confinement region. The innovations of '672 reduce the rate of erosion of the acceleration channel and/or pole surface material. As a result, several benefits are realized. For example, the life of the source is extended, less heat is generated in the source, the source is made more efficient, and less sputtered, contaminating material is ejected from the source. In addition the ion sources collimate the ion beam exiting the source to produce a more focused, useful energy beam.

The closed drift ion sources of the '672 patent include both center and outer magnets so that a balanced or symmetric magnetic field is provided in the gap between the inner pole and the outer pole. The ion sources of the '672 patent provide significant improvements over those of the prior art by operating with the balanced or symmetric magnetic fields. To achieve these improvements, the '672 patent requires the use of magnetic field sources on both sides of the pole gap. The presence of both center and outer magnets increases the complexity and cost of the ion sources, as compared to a single magnet ion sources.

Thus, there exists a need for a closed drift ion source providing balanced operating magnetic fields affording the benefits of the '672 patent ion source with simplified construction.

### SUMMARY OF THE INVENTION

In accordance with the principles of the invention, a closed drift ion source is provided in which a single magnetic source is utilized and a balanced or symmetric magnetic field is provided in the gap between the poles.

A closed drift ion source is provided that includes a source of magnetic flux that is only a single magnetic source. The source has a first pole with a first pole terminal surface and a second pole having a second pole terminal surface. A separation is defined between said first pole terminal surface and said second pole terminal surface. An anode is disposed spaced apart from the first pole and the second pole. The single magnetic source is disposed proximate to one of said first pole and said second pole to yield a first magnetic path between a first magnetic pole of the single magnetic source and the first pole terminal surface; and a second magnetic path between an opposing magnetic pole to the first magnetic pole of the single magnetic source and the second pole terminal surface. The first and said second magnetic paths form a symmetrical magnetic field in the separation.

The first and second magnetic paths can produce equal strength magnetic fields at the pole terminal surfaces on either side of the separation. The first and second magnetic paths are able to be constructed to have equal magnetic reluctances.

In embodiments of the invention, one magnetic path is shorter in length than the other magnetic path. Both magnetic paths include a first material having a first magnetic permeability. The shorter path further includes a second portion having a formed of a second material having a second magnetic permeability and is dimensioned such that the total reluctance of the shorter magnetic path is equal to the reluctance of the longer path.

In accordance with the principles of the invention, the first and the second magnetic paths are constructed to produce a minimum magnetic field strength in the separation disposed substantially equidistant from the terminal surfaces of the two poles.

A process for providing a plasma is provided that includes providing a closed drift ion source. An ionizable gas is introduced into said closed drift ion source. A closed drift electron confining region is provided in a separation between a first pole terminal surface of a first pole and a second pole terminal surface of a second pole. A source of magnetic flux of a single magnetic field source is disposed in proximity between one of the first pole or the second pole such that the length of a first magnetic path between a first magnetic pole of said magnetic field source and the first pole terminal surface of said first pole is different from the length of a second magnetic path between the opposing magnetic pole to the first magnetic pole and the second pole terminal surface of the second pole. A first magnetic path and a second magnetic path are formed such that the closed drift electron confining region is symmetric in the separation. The introduction of gas predominately into closed drift electron confining region achieves particularly good operational performance.

### BRIEF DESCRIPTION OF THE DRAWINGS

The invention will be better understood from a reading of the following description of the invention, in conjunction with the drawings with the appended drawings in which like references designate like elements between multiple figures:

FIG. 1 is a cross-section view of a prior art device;

FIG. 2 illustrates the electric and magnetic fields in the gap of the prior art device of FIG. 1;

FIG. 3 is a cross-section view of one embodiment of a closed drift ion source in accordance with the principles of the invention;

FIG. 4 is an isometric view of the ion source of FIG. 3;

FIG. 5 illustrates the electric and magnetic fields in the gap of the closed drift ion source of FIGS. 3 and 4; and

FIG. 6 is a cross-section view of another embodiment of an ion source in accordance with the principles of the invention.

### DETAILED DESCRIPTION OF THE PREFERRED EMBODIMENTS

The present invention has utility as an ion source for substrate treatment or space craft propulsion. A simplified apparatus generating symmetric and stable ion beams is provided.

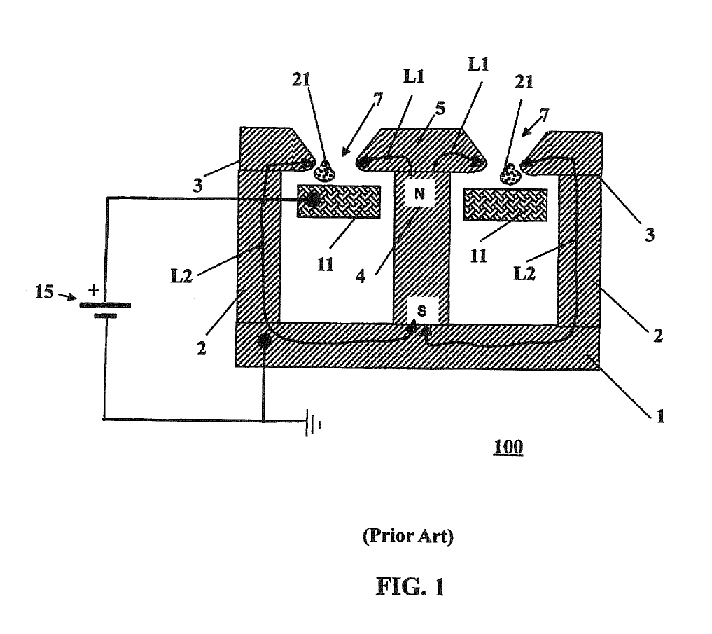

FIG. 1 illustrates a prior art ion source 100. Source 100 can either be annular or elongate and built to lengths that extend beyond three meters. Source 100 has a center pole magnet 4 and a soft iron pole system including back pole 1, side pole 2, outer pole 3 and inner pole 5. Source 100 extends inward and outward from the plane of the drawing figure to form either an annular or elongate ion source. Source 100 includes a racetrack shaped gap 7 between outer pole 3 and inner pole 5. An anode 11 is connected to the positive pole of DC power supply 15. A power supply 15 ground is connected to the cathode and the remaining ion source components. Anode 11 is electrically isolated from the poles and ground. In operation, when the power supply 15 is turned on and sufficient gas is present in gap region 7, a plasma lights in region 7 and an ion beam emerges from gap region 7.

As set forth in detail in my afore-referenced '672 patent, one problem with prior art ion sources such as source 100 results from sputter erosion. In particular, outer pole 3 is subject to sputter erosion and requires frequent replacement as a result of the asymmetric or unbalanced magnetic field.

Because ion source 100 includes a single central magnet 4, the resulting magnetic field is not symmetrical across gap 7 between inner pole 5 and outer pole 3. An unbalanced or asymmetric magnetic field is produced in gap 7 of the prior closed drift ion source 100. The magnetic field strength at one pole is stronger than the magnetic field strength at the opposite pole. The result of the imbalance in the magnetic field strengths is that the magnetic field lines are not symmetrical between the two poles. This is what is meant by the terms “unbalanced” or “asymmetric”.

In my aforementioned '672 patent, I provided an improved ion source in which a symmetric magnetic field is produced in the gap. Embodiments described in the '672 patent provide shaped poles such that strong minor fields along the central field line are created, and a symmetrical or balanced magnetic field is produced by two sets of magnets that focus the plasma in the center of the gap and optimize magnetic mirror repulsion from the poles.

Magnetic flux always forms a closed loop, as described by Maxwell's equations, but the path of the loop depends on the reluctance of the surrounding materials. Magnetic flux concentrates around the path of least reluctance. Air and vacuum have high reluctance as does aluminum, while easily magnetized materials such as soft iron have low reluctance.

Hopkinson's Law is a magnetic analogy to Ohm's law for electrical circuits. If (I) is the magnetic flux in the circuit, F is the magnetomotive force applied to the circuit, and Rm is the reluctance of the circuit, then:

F=ΦRm

where Rm is the reluctance of the magnetic circuit.

The reluctance of a uniform magnetic circuit portion is determined from

R=l/(μ₀·μᵣ·A)

where
l is the length of the circuit;
μ₀ is the permeability of free space;
μᵣ is the relative magnetic permeability of the material; and
A is the cross-sectional area.

As is apparent from the above, the length of a magnetic path directly determines the reluctance of the path. In addition, where a magnetic path includes serial portions, the total reluctance of the magnetic path is the sum or the reluctances of the portions.

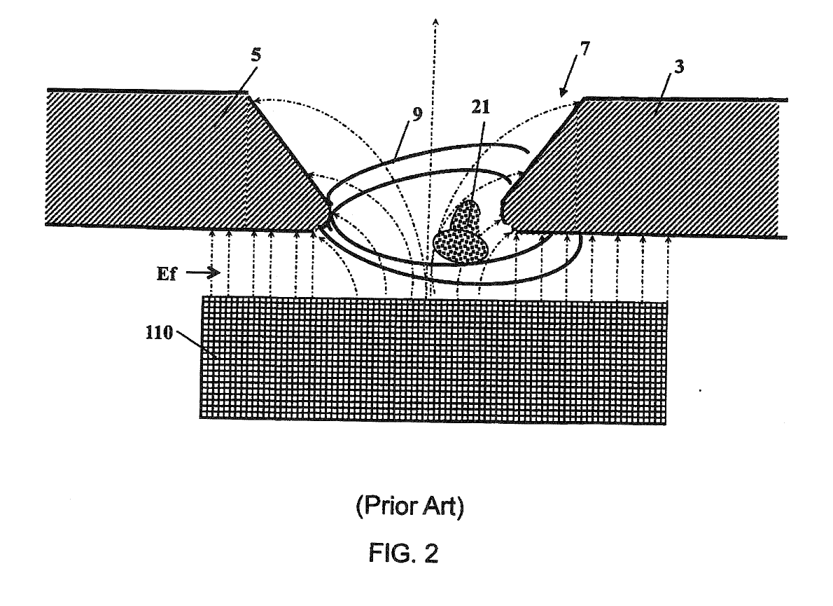

It is apparent from FIGS. 1 and 2 that the relative magnetic permeability of inner pole 5 is the same as that of outer pole 3, back pole 1 and side pole 2. L1 is the length of the magnetic path from magnet 4 to the tip of inner pole 5; L2 is the length of the magnetic path form magnet 4 to the tip of outer pole 3. Because the length of the magnetic path L1 is shorter than magnetic path L2, the reluctance of path L1 is significantly less than the reluctance of path L2. The result is that the magnetic flux density or strength B is greater at the tip of inner pole 5 than it is at the tip of outer pole 3.

The unbalanced or asymmetric magnetic field 9 produced in gap 7 shown in FIG. 2 causes the confined electrons in the closed drift region 21 to be pushed off to the weaker magnetic field side of gap 7 close to outer pole 3 as shown in FIG. 2. Closed drift region 21 is larger than the closed drift region of the embodiments of the present invention. This is because closed drift region 21 has a larger, less confined, closed drift region 21 than that of the embodiments of the inventions. Ions produced in this larger region tend to “see” a range of electric field strengths Ef.

The electric field Ef in the regions close to the outer and inner poles 3,5 is directed toward the respective pole. In the regions proximate the outer and inner poles 3,5, the electric field Ef points into the poles. This produces a wide range of ion energies exiting ion source 100, in a dispersed fashion and results in sputtering of material from outer pole 3, in particular.

Sputtering of the poles contaminates the substrate with sputtered material, causes wear of the cathode poles requiring their regular replacement, adds appreciably to the heat load the source must handle, and makes the source less energy efficient.

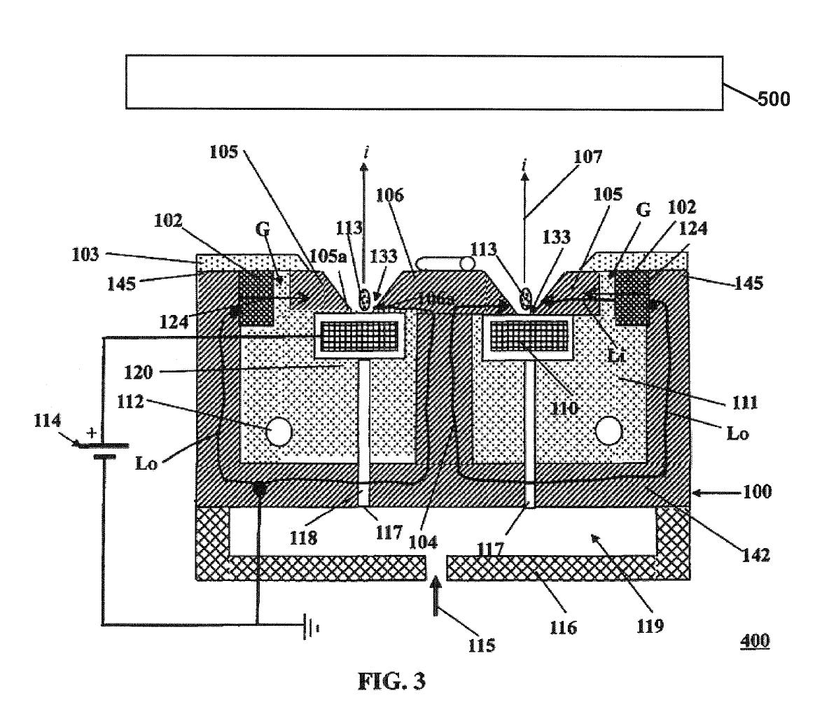

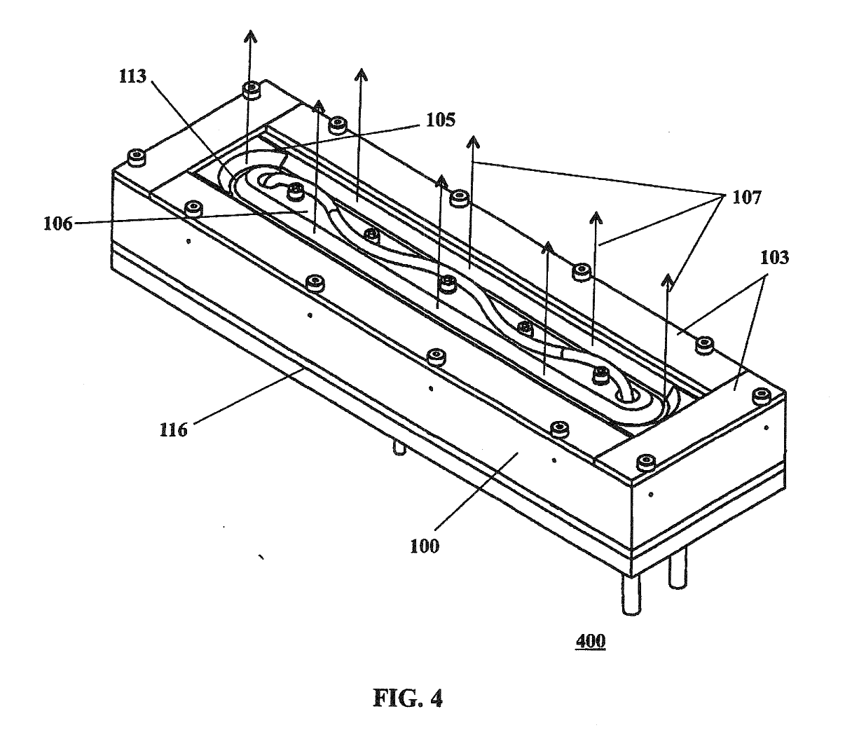

The present invention is detailed with respect to the remaining figures. FIGS. 3 and 4 show an embodiment of the present invention that is an elongate substantially rectangular anode layer ion source 400. It will be appreciated by those skilled in the art that the ion source is readily constructed in annular, oval or other geometric configuration.

Ion source 400 includes a source of magnetic flux that is only a single magnetic source 102. A magnet shunt 100 forms the main body of source 400. Shunt 100 includes a central fin 104. The shunt 100 is readily formed of a high magnetic permeability material, such as low carbon steel. Magnetic source 102 includes magnets that line the inside of shunt 100 and are each oriented to have one pole facing inward as shown by arrow 124, while the opposing pole faces outward as shown. It is appreciated that the orientation and dimensions of the two magnetic poles of the source 102 are design options for one of skill in the art. The magnets are illustratively rare earth type, ceramic, ferromagnets or other magnet types. Preferably, the magnets are rare earth magnets. Poles 105 and 106 have respective terminal surfaces 105a and 106a that are spaced apart by a separation 133. Poles 105, 106 are constructed of a high permeability material, such as low carbon steel.

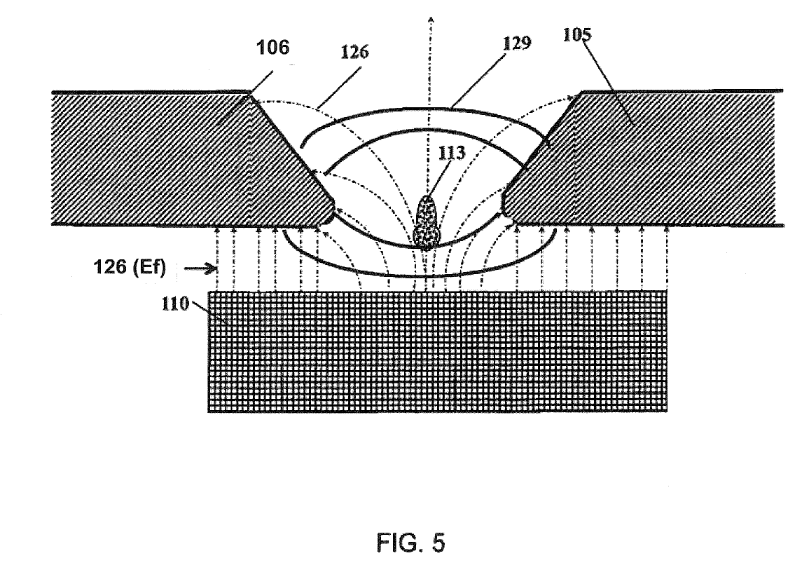

The magnetic field 129, as shown in FIG. 5, is produced by magnetic source 102 is strong enough in separation 133 to magnetically confine electrons providing a closed drift electron confining region 113 between poles 105 and 106. The magnetic field 129 between pole piece surfaces 105a and 106a is symmetrical. As used herein, “symmetrical” and “symmetry” with respect to the magnetic field confining electrons are defined as being within a ratio between the two opposing poles of 1.00-1.06:1. A magnetic field of symmetry ratio 1:1 is depicted at 129 in FIG. 5.

Outer pole piece 105 is preferably held in place and cooled by aluminum core 111 and copper top cover 103. Core 111 is preferably liquid fluid cooled. More preferably, the core 111 is water cooled via holes 112. Holes 112 are readily formed through common techniques such as gun drilling and serve to support outer pole piece 105, cool the ion source 400 and form a defined dark space region 120 around anode 110. An anode 110 is supported by ceramic spacers (not shown). The anode 110 is electrically isolated from core 111 and the rest of ion source 400. Anode 110 is constructed of non-magnetic materials such as stainless steel and is preferably water cooled by known methods.

Working gas 115 is preferably uniformly conducted into the dark space region 120 through one or more channels 118 and 117 from a plenum 119. The channels have a first end proximal to the poles 105 and 106 and a second end that extends into the dark region 120. A channel 117 or 118 is optionally in fluid communication with a gas source (not shown) from which gas 115 enter the source 400. Plenum 119 is formed between the back of shunt 100 and housing 116. More preferably, the majority of the gas 115 entering plenum 119 exits into closed drift electron confining region 113. A power supply 114 is connected between anode 110 and housing 116. Housing 116 is electrically connected to all conductive source parts except anode 110. This includes poles 105 and 106. Power supply 114 is a direct current DC supply in this embodiment with its cathode electrode grounded.

Core 111 also supports magnetic source 102 magnets and spaces magnetic source 102 from outer pole 105 by a gap or space G. In accordance with the principles of the invention, the gap G is utilized advantageously to determine characteristics of the ion beam. The gap G is readily formed of aluminum, like permeability materials, or is simply an air gap void.

FIG. 4 is an isometric view of the ion source 400 of the present invention. While the ion source 400 can be annular, many applications are benefited by the ability of anode layer ion sources to be extended linearly to uniformly treat large area substrates. The particular embodiment of ion source 400 is depicted as 24 cm long with a beam racetrack length of 16 cm and the distance between the two linear track sections is 1.25 cm. It will be apparent to those skilled in the art that the dimensions of elongate rectangular ion source 400 may be changed.

Beam 107 emanates out of closed drift electron confining region 113 between outer pole 105 and inner pole 106. Pole cover 103 is secured to front portion 145 of the housing 100 by fasteners (not shown). Gas manifold 116 is attached to rear portion 142 of the housing 100 by fasteners (not shown). As is known, the closed drift confinement of electrons in racetrack shaped separation 133 allows the extension of the source to lengths exceeding 3 meters.

As shown particularly well in FIG. 3, the length of the magnetic path Lo from the outer side of magnets 102 to the surface tip 106a of inner pole 106 is significantly longer than the length of the magnetic path Li from the inner side of magnets 102 to the surface tip 105a of the outer pole 105. The total reluctance of path Li is the sum of the reluctance of gap G, Rg plus the reluctance of outer pole 105, R₁₀₅.

Advantageous use is made of the gap G provided by a core 111. Aluminum has a relative permeability of 1.000022 which is not significantly different from the permeability of free space. The length of gap G is selected such that the total reluctance Rg+R₁₀₅ is equal to reluctance Ri.

Stated in terms of relationships for the embodiment of FIG. 4,

Rg+Ro=Ri .

In operation, when power supply 114 is turned on and gas 115 is flowing into the source 400, a sharp electric field is generated in region 113 between the anode 110 and poles 105 and 106. Electrons trapped by the closed drift magnetic field 129 in region 113 receive energy from this electric field and, in turn, ionize gas 115 flowing into region 113, the resultant ions 107 are pulled out of the source by the electric field creating a sustained beam of energetic ions 107 out of the source 400, synonymously referred to as anion beam.

Because gap G is utilized to adjust the reluctance in the magnetic paths to provide equal reluctances, the magnetic field in separation 133 is symmetrical and ion beam 107 has a neutral tilt.

In operation with a sufficient positive voltage applied to anode 110 and sufficient gas pressure in the gap, electrons in the gap region attempt to move from the cathode poles 105 and 106 toward anode 110. While, following electric field lines 126, the electrons are initially able to move along magnetic field lines 129. However, in the center of the gap, the electric field lines 126 cross magnetic field lines 129 and the electrons are impeded by the crossing magnetic field lines 129 by Lorentz forces. As is known, crossed electric field and magnetic fields force the electrons to move in the Hall current direction and, with the racetrack shape of the gap, an endless, closed drift electron current in region 113 is formed.

An ion beam 107 is created when ions, formed in the dense electron current of region 113, experience the electric field, Ef and 126 and are accelerated out of the separation 133 between the poles 105 and 106. Beam 107 is then used to treat a substrate 500 or perform some other useful purpose, such as accelerating a space vehicle. The substrate 500 is appreciated to be stationary or moving relative to the source 400. Treatments illustratively include sputter cleaning, annealing, or coating deposition thereon.

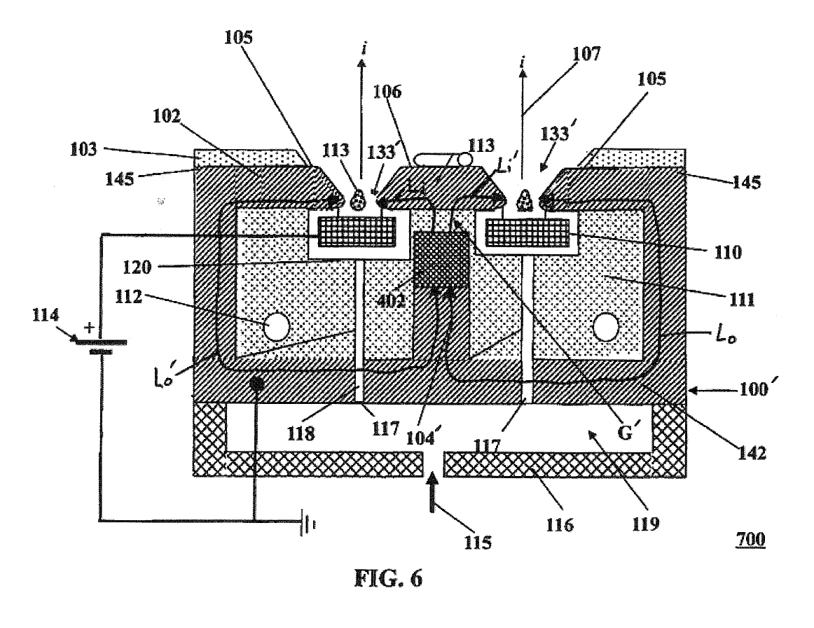

FIG. 6, shows another inventive embodiment of an ion source 700 where like numerals correspond to the meanings ascribed thereto with reference to the aforementioned figures. Ion source 700 differs from ion source 400 of FIGS. 3 and 4 in that the magnetic source 402 is provided in the center fin of the shunt 100′ and the gap G′ is provided between magnetic source 402 and inner pole piece 106. In this embodiment the shorter magnetic path Li′ includes the inner pole 106′. As with the embodiment of FIGS. 3 and 4, the reluctance of the paths Li′ and Lo′ from magnetic source 402 to the pole piece ends 105 and 106 is made equal to produce asymmetric magnetic field as in FIG. 5.

Ion source 700 includes a single magnetic source 402. A magnet shunt 100′ forms the main body of source 700 and like shunt 100 is formed of a high permeability material such as low carbon steel. Shunt 100′ includes a central fin 104′. Magnetic source 402 includes magnets supported on central fin 104′. In the embodiment, the magnets are rare earth type magnets although ceramic or other magnet types can be used. Pole 105, 106 have terminal surface and are spaced apart by a separation 133′. Poles 105, 106 are constructed of a high permeability material such as low carbon steel.

The magnetic field produced by magnetic source 402 is symmetrical and strong enough in separation 133 to magnetically confine electrons providing a closed drift electron confining region 113 between poles 105, 106.

Central fin 104′ also supports magnetic source 402 magnets and spaces magnetic source 402 from inner pole 106 by a gap or space G′. In accordance with the principles of the invention, the gap G′ is utilized advantageously to determine characteristics of the ion beam and confined plasma produced. It will be appreciated by those skilled in the art that although gap G′ comprises aluminum, it could be constructed of other material or be an air gap.

The length of the magnetic path Lo′ from the top side of magnetic source 402 to the surface tip of inner pole 106 is significantly shorter than the length of the magnetic path Lo′ from the bottom side of magnetic source 402 to the surface tip of the outer pole 105. The total reluctance of path Li′ is the sum of the reluctance Rg of gap G plus the reluctance R₁₀₆ of inner pole 106.

Advantageous use is again made of the gap G′ provided by core 111. The length of gap G′ is selected such that the total reluctance Rg′+R₁₀₆ is equal to reluctance Ro; where Rg is the reluctance of gap G′, R₁₀₆ is the reluctance of the path through inner pole 106 and Ro′ is the reluctance of the path from magnetic source 402 to the surface tip of pole 105.

Stated in terms of relationships for the embodiment of FIG. 4,

Rg′+R₁₀₆=Ro′.

Because gap G is utilized to adjust the reluctance in the magnetic paths to provide equal reluctances, the magnetic field in separation 133 is symmetrical and ion beam 107 has a neutral tilt.

References detailed herein are incorporated by reference to the same extent as if each such reference was individual and specifically included within the specification.

It will be appreciated by those skilled in the art that various changes and modifications may be made to the structures shown and described without departing from the scope of the invention. The invention has been described in terms of different embodiments. It is not intended that the invention be limited to the embodiments shown and described but that the invention be limited only by the scope of the claims appended hereto or as later added or amended.

What is claimed is:

1. A closed drift ion source, comprising:
a source of magnetic flux consisting of a single magnetic source;
a first pole, said first pole having a first pole terminal surface;
a second pole, said second pole having a second pole terminal surface;
a separation between said first pole terminal surface and said second pole terminal surface;
an anode disposed spaced apart from said first pole and said second pole;
said single magnetic source disposed proximate to one of said first pole and said second pole;
a first magnetic path between a first magnetic pole of said single magnetic source and said first pole terminal surface;
a second magnetic path between an opposing magnetic pole to the first magnetic pole of said single magnetic source and said second pole terminal surface;
said first and said second magnetic paths forming a symmetrical magnetic field in said separation.

2. The closed drift ion source in accordance with claim 1, further comprising:
a channel having an first end and a second end;
said first pole disposed proximal to said first end of said channel and said second pole disposed proximal to said first end of said channel.

3. The closed drift ion source in accordance with claim 2, wherein:
said anode is disposed in said channel.

4. The closed drift ion source in accordance with claim 2, further comprising:
an input port in said channel for an ionizable gas.

5. The closed drift ion source in accordance with claim 1, wherein:
said first and said second magnetic paths have magnetic fields at said first pole terminal surface and said second pole terminal surface with a ratio of between 1.00-1.08:1.

6. The closed drift ion source in accordance with claim 1, wherein:
said first and said second magnetic paths are constructed to have equal magnetic reluctances.

7. The closed drift ion source in accordance with claim 6, wherein:
said second magnetic path is shorter in length than said first magnetic path.

8. The closed drift ion source in accordance with claim 7, wherein:
said first magnetic path is through a first material having a first permeability; and
said second magnetic path is through a first portion of said first material, and a second material having a second permeability.

9. The closed drift ion source in accordance with claim 8, wherein:
said second material is dimensioned such that the total reluctance of said second magnetic path is equal to the reluctance of said first magnetic path.

10. The closed drift ion source in accordance with claim 8, wherein:
said second permeability and the length of said second material are selected such that the total reluctance of said second magnetic path is equal to the reluctance of said first magnetic path.

11. The closed drift ion source in accordance with claim 7, wherein:
said single magnetic source is a permanent magnet.

12. A process for providing a plasma, comprising:
providing a closed drift ion source;
introducing an ionizable gas into said closed drift ion source;
providing a closed drift electron confining region in a separation between a first pole terminal surface of a first pole and a second pole terminal surface of a second pole;
providing a source of magnetic flux consisting of a single magnetic field source disposed in proximity between one of said first pole or said second pole such that the length of a first magnetic path between a first magnetic pole of said magnetic field source and said first pole terminal surface of said first pole is different from the length of a second magnetic path between the opposing magnetic pole to said first magnetic pole and said second pole terminal surface of said second pole; and
forming said first magnetic path and said second magnetic path such that said closed drift electron confining region is symmetric in said separation.

13. The process in accordance with claim 12, further comprising:
constructing said first magnetic path and said second magnetic path to provide strength magnetic fields at said first pole terminal surface and said second pole terminal surface with a ratio of between 1.00-1.08:1.

14. The process in accordance with claim 13, wherein:
said first magnetic path and said second magnetic path have equal magnetic reluctances.

15. The process in accordance with claim 14 comprising:
including in a shorter of said first path and second magnetic path, a portion formed of a first material having a magnetic permeability and length selected such that said shorter magnetic path has the same reluctance as a longer of said first path and second magnetic path.

16. The process of in accordance with claim 12 wherein the introducing said ionizable gas into said closed drift ion source is predominantly into closed drift electron confining region.
